(19) United States
(12) Patent Application Publication
(10) Pub. No.: US 2006/0108434 A1
(43) Pub. Date: May 25, 2006

(54) Impartial co-management to aid crop marketing

(75) Inventor: Daniel Robert Kallestad, Chino Hills, CA (US)

Correspondence Address: MERCHANT & GOULD PC, P.O. BOX 2903, MINNEAPOLIS, MN, 55402-0903, US

(73) Assignee: Cerys Systems Inc., Chino, CA (US)

(21) Appl. No.: 11/305,054

(22) Filed: Dec. 16, 2005

Related U.S. Application Data
(63) Continuation-in-part of application No. 10/217,312, filed on Aug. 8, 2002, now Pat. No. 7,004,401.
(60) Provisional application No. 60/311,752, filed on Aug. 10, 2001.

(51) Int. Cl. F24F 7/00; G06Q 40/00; G01M 1/38; G06F 17/00; G05B 13/00

(52) U.S. Cl. 236/49.3; 700/277; 705/400; 705/4

(57) ABSTRACT

Impartial co-management to aid crop marketing is disclosed. A crop co-manager is associated with a plurality of crop storage facilities. The crop co-manager receives facility data that indicates conditions that are associated with the respective crop storage facility. The crop co-manager selects/generates a policy to co-manage the crop storage facility in light of the facility data. A controller controls the crop storage facility according to the policy and generates data for a crop management history record. The crop management history record is associated with the crop co-manager. Limited access to the crop co-manager is available to one or more market participants in order to promote an impartial, reliable, and fraud proof crop market.

### RELATED APPLICATIONS

This utility patent application claims the benefit under 35 United States Code § 120 of U.S. patent application Ser. No. 10/217,312 filed on Aug. 8, 2002, which claims the benefit to U.S. Provisional Application No. 60/311,752 filed Aug. 10, 2001.

### BACKGROUND

After harvesting, crops are usually stored in a storage bin before they are sold or brought to market. The storage and data associated with the storage are generally left in the hands of the manager of the individual bins. The management is generally localized with respect to a bin, and the management of data associated with the bin is generally only available to the managers of the individual bin.

### SUMMARY

This Summary is provided to introduce a selection of concepts in a simplified form that are further detailed below in the Detailed Description. This Summary is not intended to identify key elements or essential features of the claimed subject matter, nor is this Summary intended to be used as an aid in determining the scope of the claimed subject matter.

Aspects of the present disclosure include impartial co-management to aid crop marketing. A crop co-manager is associated with a plurality of crop storage facilities. In aspects of the present disclosure, the crop storage facilities include one or more nodes and one or more controllers. The crop co-manager receives facility data that indicates conditions that are associated with the respective crop storage facility from the one or more controllers. The crop co-manager selects a policy to co-manage the crop storage facility in light of the facility data. The controller controls nodes of the crop storage facility according to the policy and the controller transmits data to the crop co-manager for a crop management history record. Limited access to the crop co-manager is available to one or more market participants in order to promote an accountable, streamlined, impartial, reliable, and fraud proof crop market.

A more complete appreciation of the present disclosure and its improvements can be obtained by reference to the accompanying drawings, to the detailed description, and to the appended claims.

### BRIEF DESCRIPTION OF THE DRAWINGS

FIG. 1 illustrates an exemplary computing device that may be used in one aspect of the present disclosure;

FIG. 2 illustrates an exemplary mobile device that may be used in one aspect of the present disclosure;

FIG. 3 represents one exemplary system diagram of some aspects of impartial co-management to aid crop marketing;

FIG. 4 represents one exemplary system diagram of some aspects of impartial co-management to aid crop marketing;

FIG. 5 represents one exemplary logical flow diagram of one aspect of co-managing a crop market according to a policy;

FIG. 6 represents one exemplary logical flow diagram of one aspect of evaluating the sufficiency of a policy; and

FIG. 7 represents one exemplary logical flow diagram of one aspect of evaluating a request for access to data associated with a crop co-manager.

### DETAILED DESCRIPTION

Embodiments of the present disclosure will be described in detail with reference to the drawings, where like reference numerals represent like parts and assemblies throughout the several views. Reference to various embodiments does not limit the scope of the disclosure, which is limited only by the scope of the claims attached hereto. The examples set forth in this specification are not intended to be limiting and merely set forth some of the many possible embodiments for the claimed disclosure. The following detailed description is, therefore, not to be taken in a limiting sense.

Illustrative Embodiments of Impartial Co-Management to Aid Crop Marketing

Succinctly stated, aspects of some embodiments of the present disclosure are related to impartial co-management to promote reliability, efficiency, safeness, and accountability with regard to a crop industry. Aspects of some embodiments are also related to impartial co-management where unscrupulous operators of crop storage facilities cannot spoof or defraud the system. Aspects may include a plurality of crop storage facilities located throughout a large geographical area at various remote sites. In one aspect, the crop storage facilities may be in communication with a virtual crop co-manager at a remote co-manager site through an encrypted network. The crop co-manager may receive facility data from the plurality of crop storage facilities, transmit policy data to the crop storage facilities, and record a crop management history of the crop storage facilities for use in a crop market and allow input of transactional data associated with crop transactions.

As another succinct example of the functionality of some embodiments, the crop co-manager may be associated with a market participant through a secure network. The market participant may have limited access to data associated with the crop co-manager. The access may include public access (e.g. individuals not affiliated with the co-management service), customer access (e.g. individuals affiliated and/or subscribers to an aspect of the co-management service) or restricted access (e.g. no individuals have access without special permission). As an example, on occasion, a government entity may be given restricted access to information that is inaccessible to everyone else. As another example, a crop owner may have customer access to log data regarding a crop that is stored in the crop storage facility. A crop owner may also have access to log a crop storage objective that is associated with storage and/or transportation of a crop. However, the crop owner may not have access to the policy settings (which may be restricted) transmitted from the crop co-manager to the crop storage facility in order to maintain the crop storage objectives. In this example, a crop owner has access to set objectives for a stored crop. However, the crop owner does not have access to implement a policy to carry out the objectives. The crop co-manager carries out such an implementation. In this manner, maintenance of the crop objective is delegated to the crop co-manager, which reduces crop owner guesswork.

As another example, a crop buyer, bank or insurance company may have customer access to crop history data or customer access to input transactional data regarding a crop transaction. However, in one aspect, the crop buyer, bank or insurance company may not be able to log crop objective data regarding the storage and/or the crop. In another aspect, the crop buyer, bank or insurance company does not have access to change or modify a policy implemented by the crop co-manager. In this manner, as is further set forth herein, aspects of the present disclosure promote reliability in crop quality, increase storage efficiency, promote a crop trade, create an efficient crop market for on-line transactions, increase the traceability of a crop, and decrease spoofing and fraud. Other aspects of the present disclosure promote implementation of a uniform crop storage standard across a large geographic area or across a crop market.

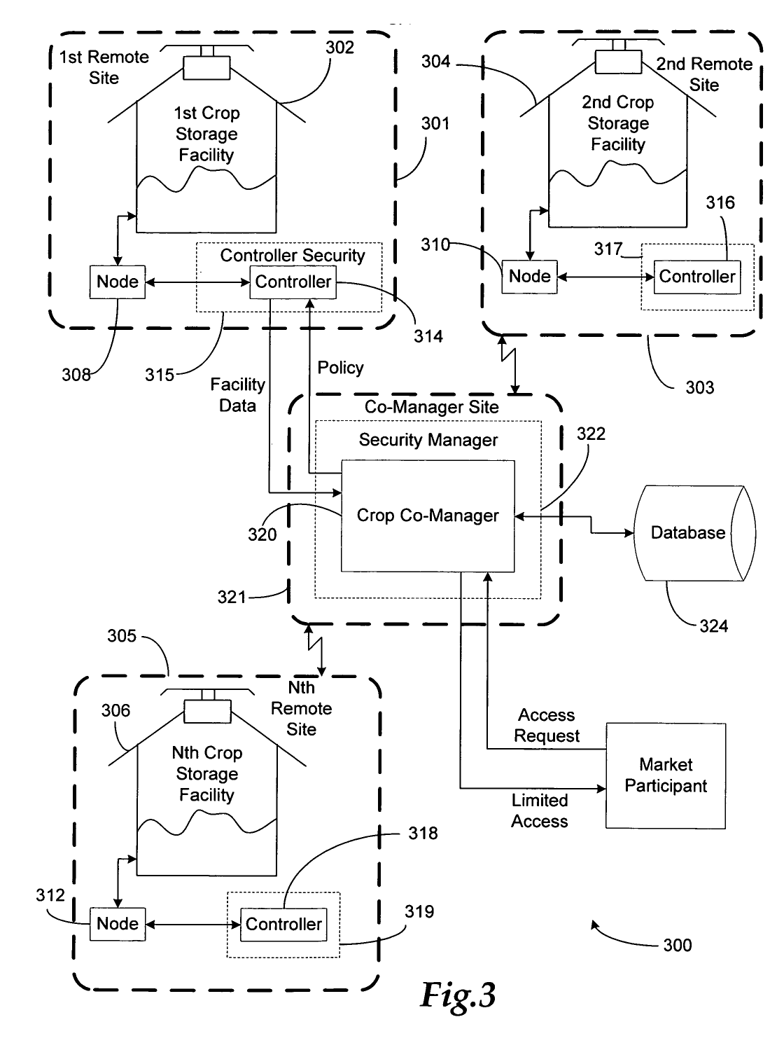

FIG. 3 represents one exemplary system overview 300 for impartial co-management to aid crop marketing. System 300 represents a general modular overview of aspects of the present disclosure. Aspects of system 300 may be integrated as a combination of software and hardware elements, an operating system or any combination thereof. Hardware, databases, software, applications, nodes and storage facilities referenced herein may be integrated as a single element or include various elements in communication with one another.

Software elements, hardware elements, nodes, controllers, storage facilities, databases, managers and other system elements are depicted herein for explanatory purposes only and not for limiting the configuration to multiple elements or a single element performing several functions. System 300 may reside on a single computing device or a plurality of computing devices and servers in communication with one another.

In FIG. 3, system 300 may include first remote site 302 having first crop storage facility 302, second remote site 303 having second crop storage facility 304, and Nth remote site 305 having Nth crop storage facility 306. Crop storage facilities 302, 304, and 306 may include nodes, controllers and security as indicated by reference numbers 308-319, respectively. System 300 may also include a co-manager site 321 having crop co-manager 320, security manager 322, database 324 and market participant 326. Reference numbers 301-326 may include separate system elements, separate programs, separate databases, separate computing devices and separate hardware. Reference numbers 301-326 may also include multiple system elements, multiple programs, databases, computing devices, hardware or any combination thereof.

In FIG. 3, system 300 may include crop storage facilities 302, 304, and 306. In that crop storage facilities 302, 304 and 306 may include similar aspects and embodiments, crop storage facility 302 is primarily referenced hereafter. However, aspects of crop storage facility 302 also apply to crop storage facilities 304 and 306.

Aspects of crop storage facility 302 may include a crop silo, crop bin or any other type of storage that is capable of maintaining a crop, grain, seed and/or any other type of agricultural product. In one embodiment of the present disclosure, crop storage facility 302 includes a crop transportation vehicle. In such a situation, the holding area of the crop transportation vehicle is a crop storage facility.

Crop storage facilities 302, 304, and 306 may be located at a single site or at separate remote sites throughout a large geographical region as indicated by reference numbers 301, 303, and 305, respectively. For example, first remote site 301 may be located in California and second remote site 303 may be located in Nebraska. Crop storage facilities 302, 304, and 306 may have similar owners or be independently owned by different entities. Crop storage facilities 302, 304 and 306 may include separate entities of a crop market that participate in aspects of impartial co-management to aid crop marketing. Also, even though first remote site 301, second remote site 303 and Nth remote site 305 depict a single crop storage facility associated therewith, each remote site 301, 303 and 305 may include a plurality of crop storage facilities. Such a plurality of crop storage facilities may include a grain reserve and/or aspects of a common grain elevator.

Crop storage facilities 302, 304 and 306 may be associated with nodes 308, 310, and 312, respectively. In that nodes 308, 310 and 312 may include similar aspects and embodiments, node 308 is primarily referenced hereafter. However, aspects of node 308 may also apply to nodes 310 and 312.

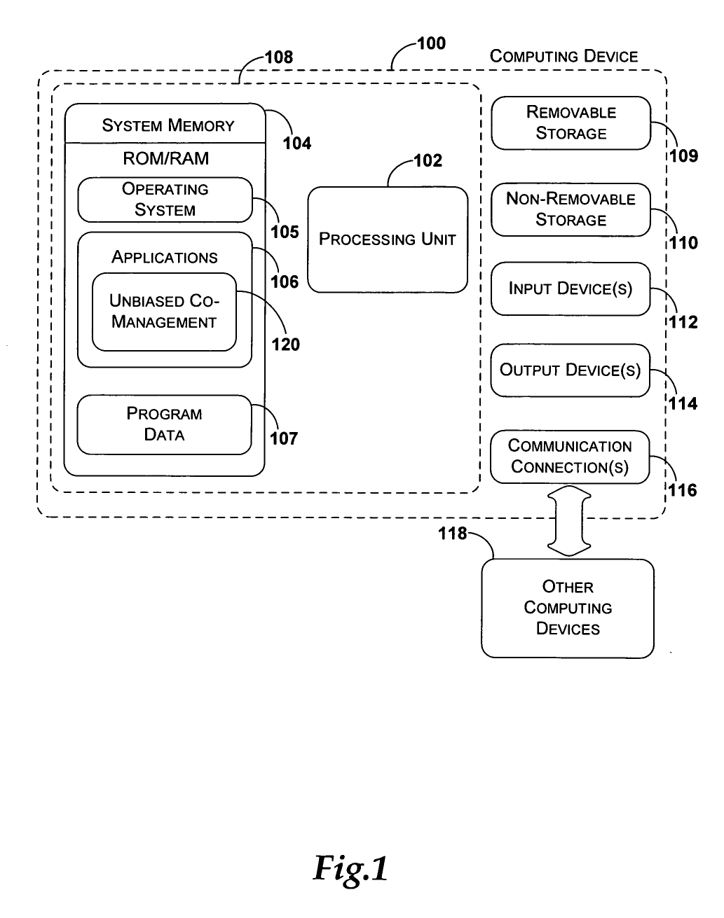

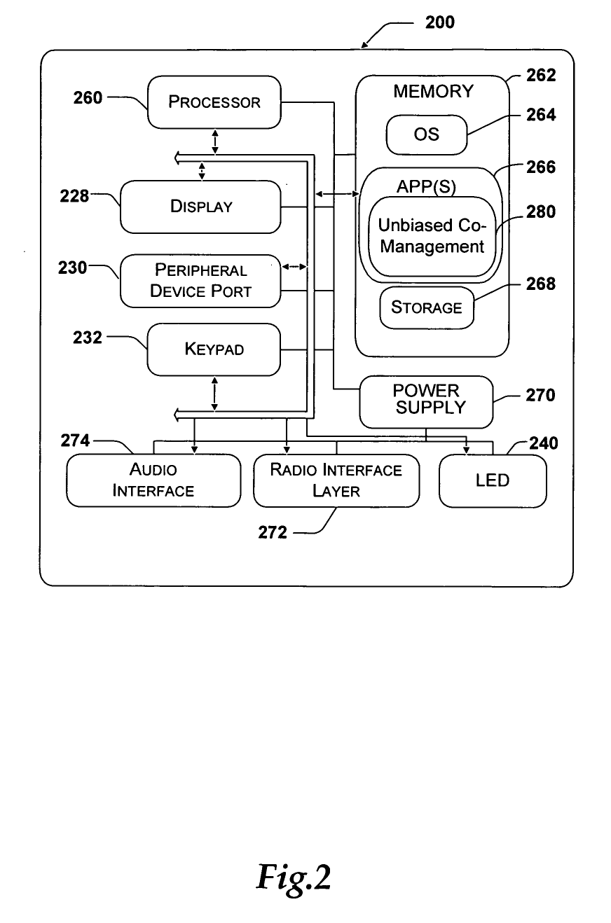

Aspects of node 308 may include computing device 100 as exemplified in FIG. 1 and/or mobile computing device 200 as exemplified in FIG. 2. Aspects of node 308 may also include a micro-controller and a communication interface associated with controller 314. The communication interface may include an Ethernet interface, a twisted pair-cabling interface, a wireless interface, a fiber optics interface, a power line carrier and/or the like. In general, the communication interface may include any type of interface capable of sending and/or receiving data to/from controller 314 and/or crop co-manager 320.

Node 308 may include a sensor and/or a rectifier. The sensor of node 308 may sense conditions outside and/or inside crop storage facility 302. Node 308 may also include sensors that monitor crop condition, power condition, storage facility condition and/or environmental conditions. The rectifier of node 308 may include an actuator for changing the condition of crop storage facility 302 and/or the crop in accordance with a policy implemented by crop co-manager 320.

As a few examples of node 308, a weather node may include one or more sensors for sensing weather conditions. A temperature node may include one or more sensors for sensing the temperature and one or more rectifiers for changing the temperature (e.g. heaters and/or air chillers). A relative humidity node may include one or more sensors for sensing the relative humidity and one or more rectifiers for changing the relative humidity. A barometric pressure node may include one or more sensors for sensing barometric pressure. A Global Positioning System (“GPS”) node may include a sensor for sensing a position at a moment in time. For example, in the situation where crop storage facility 302 includes a crop transportation vehicle, a GPS node may be beneficial to determine the location of the crop while in transport. As another example, the GPS node may communicate position in combination with a weather node sensing and communicating weather at the position. In this manner, weather conditions may be identifier over a geographic area as obtained from a plurality of crop storage sites.

Node 308 may include a Radio Frequency Identification (“RFID”) transmitter to facilitate tracking and identification of a crop while being transported. For example, a transportation vehicle may include an RFID transmitter. The transmitter may be identified and/or logged when loading the transportation vehicle with a crop and then again when the crop is unloaded at a destination. In one aspect, such an identification and/or logging may include an RFID receiver and/or wand for receiving data from a transmitter. Such position information may be beneficial for traceability of the crop and for proactive commingling of one or more crops. A static pressure node may include a sensor for sensing the static pressure associated with crop storage. A crop weight and/or mass node may include a sensor for determining the weight of a crop. A crop heater node may include a rectifier for heating crop storage facility 302. A crop fan node may include a rectifier or fan for drying a crop. A crop mister node may include a rectifier for changing the moisture content of a crop. A power node may include a sensor for sensing the amount of power consumption of crop storage facility 302 and/or a rectifier for adjusting and/or timing the power consumption of crop storage facility 302. In general, node 308 may include any type of node for sensing and/or rectifying a condition of the environment, crop storage facility 302, and/or the crop.

In other aspects of node 308, node 308 includes software, firmware, instructions or the like for determining the status of an associated sensor and communicating the status to controller 314. In one aspect, node 308 also includes an address or identifier that identifies node 308 to controller 314 to facilitate the generation of a crop management history record.

Node 308 may include instructions to detect memory faults or failures before operation. Node 308 may include a timer, which must be cleared periodically to prevent the controller from being reset. The timer ensures that if the controller malfunctions, it is reset to a clear state after a specified time interval. When node 308 detects such a failure, node 308 shuts off equipment to avoid damaging the contents of crop storage facility 302. The failed node enters a sleep mode and controller 314 detects the sleep mode and reports failure to crop co-manager 320.

Even though node 308 is depicted in FIG. 3 as a single node, node 308 may include a plurality of sensors and rectifiers in combination with a single node. In other embodiments, node 308 includes a plurality of nodes. The type and number of nodes associated with a crop storage facility will depend, in part, on the objectives for the stored crop and/or an associated crop market.

Crop storage facilities 302, 304, and 306 may be associated with controllers 314, 316 and 318, respectively. In that controllers 314, 316, and 318 may include similar aspects and embodiments, controller 314 is primarily referenced hereafter. However, aspects of controller 314 also apply to controllers 316 and 318.

Aspects of controller 314 may include aspects of computing device 100 as exemplified in FIG. 1 and/or mobile computing device 200 as exemplified in FIG. 2. In one embodiment, controller 314 is interfaced with node 308. The communication interface may include a serial communication interface, a parallel communication interface, an Ethernet interface, a twisted pair-cabling interface, a wireless interface, a fiber optics interface, a power line carrier, and/or the like. In another embodiment, controller 314 is interfaced with crop co-manager 320. The communication interface may include an Ethernet interface, a twisted pair cabling interface, a wireless interface, a fiber optics interface, a power line carrier, a DSL interface, a cable interface, a satellite interface, a dial-up interface, any type of WAN technology interface, and/or the like.

Controllers 314, 316 and 318 may include or be associated with controller security 315, 317 and 319, respectively. In one embodiment, controller security 315 may include a biometric identification login, a web-based login, a secure web based login, a virtual private network link, a client application based login, an encrypted login, a modem-based login, and/or a dialup based login. In another embodiment, controller security 315 includes asymmetric public key cryptography, one time pad encryption and/or a security hash algorithm. Controller security 315 may be arranged to receive a request for access, determine an access level associated with the identified market participant, and reject requests from the identified market participant when the determined access level is insufficient for the request. Generally, controller 314 is accessible to a crop owner of first remote site 301. In one aspect, access is granted to a crop manager upon evaluation of an access level via controller security 315. In this manner, a crop manager may securely input crop storage objectives for a crop. However, in one aspect, the crop manager does not institute a policy to carry out the crop storage objectives. The crop co-manager may institute such a policy.

Aspects of controller 314 may include a master/slave relationship with node 308, where controller 314 is the master and node 308 is the slave. Aspects of controller 314 may also include a master/slave relationship with crop co-manager 320 where crop co-manager 320 is the master and controller 314 is the slave. In one embodiment of controller 314, controller 314 polls the status of node 308 and controls node 308 in accordance with a policy from crop co-manager 320. Controller 314 may adjust node 308 in association with one or more policies of crop co-manager 320. The policies may be executed by controller 314 in an iterative closed-loop manner. Controller 314 polls node 308 for status, associates the status with the policy and transmits control updates to node 308 in accordance with the policy. This process may be repeated to maintain the crop in accordance with one or more objectives. In one aspect, controller 314 securely transmits objectives to crop co-manager 320 to facilitate the generation of an initial policy. In another aspect, controller 314 generates facility data that includes data associated with the operation of the nodes and/or controller activity. The facility data may be transmitted to crop co-manager 320 for use in a crop management history report and/or for updating a policy.

Even though controller 314 is depicted in FIG. 3 as a single controller, controller 314 may include a plurality of controllers. The type and number of controllers associated with a crop storage facility will depend in part on the objectives for the stored crop and/or an associated crop market.

System 300 also includes co-manager site 321 having crop co-manager 320. Crop co-manager 320 may include aspects of computing device 100 as exemplified in FIG. 1 and/or mobile computing device 200 as exemplified in FIG. 2. Crop co-manager 320 may also include a server interfaced with a plurality of crop storage facilities. Crop co-manager 320 may also be interfaced with database 324 and market participant 326. The communication interface may include a serial communication interface, a parallel communication interface, an Ethernet interface, a twisted pair-cabling interface, a wireless interface, a fiber optics interface, and/or a power line carrier. In another embodiment, the communication interface may include a DSL interface, a cable interface, a satellite interface, a dial-up interface, any type of WAN technology interface, and/or the like.

Crop co-manager 320 may obtain facility data on a periodic and/or continuous basis from controller 314. In one aspect, crop co-manager 320 requests facility data from controller 314. Controller 314 transmits the facility data upon receiving the request. In another aspect, crop co-manager 320 receives a notification from controller 314 indicating that controller 314 has facility data. Crop co-manager 314 requests facility data from controller 314, and controller 314 transmits the facility data upon receiving the request. In another aspect, crop co-manager 320 polls controller 314 periodically for facility data. In yet another aspect, controller 314 sends data to crop co-manager 320 periodically.

The facility data may be used to calculate an initial policy and/or update a current policy for the crop storage facility 302, where the policy is transmitted to controller 314. In one embodiment, the facility data includes initial facility data that may be logged upon initial storage. In one aspect, initial facility data may include initial crop data. Such initial crop data may include a crop objective, crop origin, initial crop condition, crop destination, crop ownership, origin field data, or any other type of initial crop data. In other aspects, initial facility data includes initial facility specifications. Such initial facility specifications may include crop storage facility specifications, bin specifications, fan specifications, equipment specifications, and/or any other specifications associated with the initial storage of a crop. The initial facility data may be logged at controller 314 by an operator with an appropriate access level. In another embodiment, the initial facility data is logged by market participant 326 having an appropriate access level.

A policy may be calculated in light of the initial facility data. For example, the initial facility data may indicate a crop objective, a desired crop grade, a storage time, a transportation date, a desired moisture content, conditional thresholds for maintaining the crop, crop type, crop origin, and the like. Crop co-manager may evaluate the initial facility data to select/generate a policy accordingly.

Crop co-manager 320 may determine whether a current policy is sufficient when crop co-manager 320 receives facility data from controller 314. For example, crop co-manager 320 may get facility data from controller 314. Crop co-manager evaluates the facility data. Evaluation of facility data may include evaluation of an instantaneous condition, average condition over a time period, rate of change of a condition, the mean of a condition over a time period, and the like. Evaluation may also include changes in initial facility data instituted by a crop owner. Crop co-manager 320 may use the evaluated facility data and/or changed initial facility data to modify an existing policy, select a new policy, and/or generate a new policy. The policy may be used by controller 314 to adjust the settings of node 308 accordingly.

As one succinct example, a crop owner may desire storage associated with an objective such as a grade A crop. The crop owner receives customer access to crop co-manager 320. The crop owner accesses crop co-manager 320 through a secure login and enters initial facility data and data associated with the grade A crop objective. In response, crop co-manager 320 selects/generates policy settings associated with a grade A crop objective. Crop co-manager 320 transmits the policy settings to controller 314. Controller 314 controls node 308 in accordance with the policy settings. Node 308 transmits node data to controller 314, and controller 314 sends facility data to crop co-manager 320 to determine whether the objective is being achieved. Crop co-manager 320 evaluates the facility data. When the evaluated facility data indicates that a different policy is required to maintain a grade A crop, crop co-manager 320 transmits a new and/or modified policy to controller 314. In this manner, a crop owner may determine an objective without calculating a policy to achieve an objective. The policy data is managed by crop co-manager 320.

In other aspects of crop co-manager 320, crop co-manager 320 is configured to generate/record crop management history data from the facility data. The crop management history data may be stored in database 324 for limited access by a market participant that has an appropriate access level. For example, crop management history data may include tracking data. The tracking data may include the field origin of the crop, the owner of the crop and/or data associated with the movement of a crop. In other aspects, crop management history data may include data associated with proactive commingling to facilitate traceability during crop blending. Crop management history data may also include a record of the execution of policies on the nodes. In other embodiments, crop management history data includes a log of environmental conditions at the crop storage facility, a log of power consumption of the crop storage facility, a log of RFID data and/or shipping data that is associated with the crop storage facility, purchase and sale data associated with the crop, escrow data, escrow conditions, crop owner data, crop grade data, crop objective data, and/or node actuation data. Crop co-manager 320 may be configured to store a record associated with any aspect of a crop market that may be beneficial to a market participant.

Crop co-manager 320 allows limited access to data and configurations in association with an access level. An access level may include a public access level where data is publicly accessible. For example, a public access level may include access for individuals who do not subscribe to the co-management service. Such an individual may log onto an Internet site and obtain access to insensitive data associated with the co-management service. An access level may also include a customer access level where data is accessible to a service subscriber. An access level may further include a restricted access level for highly sensitive data. In one embodiment, restricted access is granted to market participants having a high level of accountability (e.g. government entity). In one embodiment, the policy settings that are sent to controller 314 are not accessible by market participant 326. In another embodiment, crop management history data is not modifiable by market participant 326. Stated another way, policies and crop management history data are free from outside influence, corruption, fraud, and/or manipulation.

To provide limited access in association with an access level, crop co-manager 320 may be associated with and/or include security manager 322. The security manager may be arranged to receive a request for access from a market participant, evaluate the access level associated with the identified market participant, and reject requests from the identified market participant when the determined access level is insufficient for the request for access.

Security manager 322 may include a biometric identification login, a web-based login, a secure web-based login, a virtual private network link, a client application based login, an encrypted login, a modem-based login, and/or a dialup based login. In another embodiment, security manager 322 includes asymmetric public key cryptography, one time pad encryption and/or a security hash algorithm.

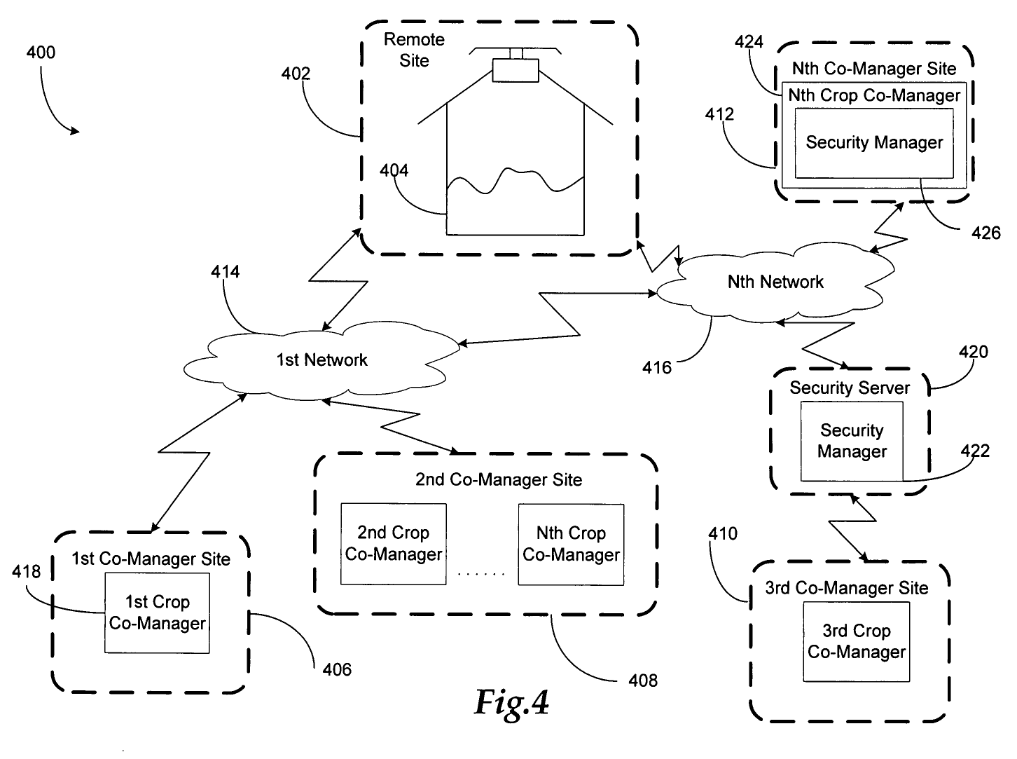

Security manager 322 may also include physical security. Physical security may include a secured building or a vault to protect crop co-managers from physical corruption. Physical security may also include several redundant, geographically dispersed, crop co-managers that back-up one another as is discussed below in association with FIG. 4. In this manner, data associated with crop co-manager 320 is secure and, in some embodiments, may not be altered. This security provides reliability of data, prevents tampering, prevents corruption, prevents fraud, allows traceability, allows for the storage of a crop according to a standard, enhances marketability and facilitates uniformity across a crop market.

Market participant 326 may include a crop owner, a financial business, an insurance business, a shipping business, a crop purchaser, a crop trade business/crop exchange market, a tracking business, a weather forecast business, a power supply business or any other business or market entity that may benefit from crop storage history data or the secured implementation of a policy.

As one example of the implementation of some embodiments with regard to a crop owner, a crop owner may load a crop into a crop storage facility. The crop owner may be given limited access to crop co-manager 320 through an associated access level such as a customer access level. The limited access may allow the crop owner to log initial facility data, which may include a crop objective. Other initial facility data may include, crop origin, initial crop condition, crop destination, crop ownership, origin field data, financial information, or any other type of initial data that may be associated with a crop in a crop market. Crop co-manager 320 receives the initial facility data and selects/generates a policy to facilitate the crop owner's objective. The policy is transmitted to controller 314 and controller 314 controls node 308 in accordance with the policy. Controller 314 generates other facility data in light of the policy implementation and transmits the facility data to crop co-manager 320 for generating a crop management history record. Crop co-manager 320 may then provide the crop owner limited access to crop management history records in accordance with an associated access level. Such a crop management history record may provide the owner data regarding the storage of a crop, transportation of a crop, bids on a crop, crop pricing or any other history beneficial to the owner's crop business. In one embodiment, the crop owner does not have direct access to the policy. In another embodiment, the crop owner may not alter the crop management history records. In this manner, a crop owner may determine the objectives for a crop and be relieved of the burden of determining how to implement the objective. Also, the shared management between the crop owner and crop co-manager 320 generates reliability, creates assurances in crop quality, increases the marketability of the crop, and promotes a crop trade.

As another example of the implementation of some embodiments with regard to a crop owner, the crop co-manager may function as an escrow service. In such a situation, a purchaser may receive limited access to crop co-manager 320 through an associated limited access level such as a customer access level. The customer access level may allow a purchaser to view data associated with a crop that is for sale by a crop owner. The purchaser may transfer funds into an account associated with crop co-manager 320. Crop co-manager 320 may hold the funds in escrow until the purchaser receives delivery of the crop and accepts the same. Once deliver is received and approved, crop co-manager 320 may release the escrowed funds to the crop owner. Such release may include transferring the funds into another account associated with crop co-manager 320. In this manner, a crop owner is given assurance of payment before delivery of the crop, the purchaser is given assurance of an acceptable crop before release of funds, and the transferability of crops in a crop market is promoted.

As one example of the implementation of some embodiments with regard to a financial business, a crop owner may contact a financial business for a loan secured by a stored crop. The financial business may be given limited access to crop co-manager 320 in association with an access level. The limited access may allow the financial business access to the crop management history records with regard to the stored crop. Such crop management history records may include storage data, crop grade data, crop origin data, proactive commingling data and/or any other data that may be useful to a financial business. From the crop management history records the financial business may receive reliable assurance of the crop quality, storage and other attributes of the crop. In one embodiment, the financial business does not have direct access to the policy data. In another embodiment, the financial business may not alter the crop management history records.

As one example of the implementation of some embodiments with regard to an insurance business, a crop owner may contact an insurance business for insurance on the storage and/or transportation of a crop. The insurance business may be given limited access to crop co-manager 320 in association with an access level. The limited access may allow the insurance business access to the crop management history records with regard to the stored crop. Such crop management history records may include storage data, crop grade data, crop origin data, proactive commingling data and/or any other data that may be useful to an insurance business. From the crop management history records the insurance business may have limited access to crop quality records, crop storage records, crop transportation records, and/or the like. This information may provide reliable assurances to the insurance company and promote insuring the crop. In one embodiment, the insurance business does not have direct access to the policy data. In another embodiment, the insurance business may not alter the crop management history records.

As one example of the implementation of some embodiments with regard to a shipping business, a crop owner may post a notice to ship a crop from one storage facility to another storage facility. The shipping business may be given limited access to crop co-manager 320 in association with an access level. The limited access may allow the shipping company to post a bid for shipping, receive a request for shipping, view crop management records, view crop transportation requirements and/or the like. In one embodiment, the transportation vehicle includes a node and a controller similar to node 308 and controller 314. Node 308 may include a GPS node and/or RFID node in order to facilitate the tracking of the crop and the transmission of facility data while the crop is in transport. In this manner, the shipping business may record crop management history data and the crop may be co-managed while the crop is in transit. In one aspect, the shipping business may then download the crop management history data to crop co-manager 320 after transportation is complete. In another embodiment, crop management history data is transmitted while the crop is being transported. This data may provide reliable assurances to the crop owner, crop purchaser, shipping business and/or other market entities of proper shipping and the condition of the crop. In one embodiment, the shipping business does not have direct access to the policy data. In another embodiment, the shipping business may not alter the crop management history records.

As one example of the implementation of some embodiments with regard to a crop purchaser, a crop purchaser may be given limited access to crop co-manager 320 in association with an access level. The limited access may allow the crop purchaser to view crop management history data associated with a crop. The crop market history data may include storage data, crop grade data, crop origin data, proactive commingling data and/or any other data that may be useful to a crop purchaser. This information may be viewed prior to making a crop purchase. This data may provide reliable assurances to the crop purchaser that the crop purchaser is purchasing a crop of a particular quality and that the crop was stored in an appropriate manner. In another aspect, a crop purchaser may have access to bid on a crop, input escrow data, open an account to transfer funds, input shipping requirements, input a desired crop grade, input a desired crop blend, and/or request/input any other data to facilitate a crop purchase. In one embodiment, the crop purchaser does not have direct access to the policy data. In another embodiment, the crop purchaser may not alter the crop management history records.

As one example of the implementation of some embodiments with regard to a crop trade/exchange market, entities of a crop trade/exchange market may be given limited access to crop co-manager 320 in association with an access level. The limited access may allow the crop trade/exchange market to view crop management history data associated with a crop. In another aspect, a crop trade/exchange may have access to bid on a crop, input escrow data, open an account to transfer funds, input shipping requirements, input a desired crop grade, input a desired crop blend, and/or request/input any other data associated with the trade of a commodity. This information may be viewed prior to making a crop purchase, purchasing a crop fund, purchasing exchange certificates or investing in a crop futures market. This data may provide reliable assurances to the crop trade/exchange market that the crop is of a particular quality and that the crop was stored/shipped in an appropriate manner. This information may be an accurate indicator of return on investment. In one embodiment, the crop trade/exchange market does not have direct access to the policy data. In another embodiment, the crop trade/exchange market may not alter the crop management history records.

As one example of the implementation of some embodiments with regard to a crop tracking business, the crop tracking business may be given limited access to crop co-manager 320 in association with an access level. The limited access may allow the crop tracking business to view crop management history data associated with a crop. This information my include information regarding the transportation of the crop, RFID data, the geographical location of the origin of a crop and/or the field origin location of a crop. In the situation where the crop needs to be traced (i.e. spoiled crop, contaminated crop, etc.), the crop may be traced back to an origin. This information may be in a view only format and securely associated with crop co-manager 320. In this manner, a crop tracing business may reliably trace a crop to an origin or an original owner. In one embodiment, the crop tracking business does not have direct access to the policy data. In another embodiment, the crop tracking business may not alter the crop management history records.

As one example of the implementation of some embodiments with regard to a business associated with aspects of proactive commingling, the business may be given limited access to crop co-manager 320 in association with an access level. The limited access may allow the business to view crop management history data associated with the commingling of one or more crops. This information my include information regarding crop quality, crop grade, the transportation of the crop, RFID data, the geographical location of the origin of a crop and/or the field origin location of a crop. In this manner, a business may reliably trace a crop to an origin or an original owner. Also, a business may efficiently ascertain the make-up of a stored crop. In one embodiment, the business does not have direct access to the policy data. In another embodiment, the business may not alter the crop management history records.

As one example of the implementation of some embodiments with regard to a weather forecast business, the weather forecast business may be given limited access to crop co-manager 320 in association with an access level. In one embodiment, crop co-manager 320 is associated with a plurality of crop storage facilities across a vast geographical area. The crop storage facilities may include Global Positioning Service nodes and weather nodes. Accordingly, position and weather data is included in the crop management history records that are associated with crop co-manager 320. This data may provide a weather forecast business with reliable weather data across a vast geographical area. In one embodiment, the weather forecast business does not have direct access to the policy data. In another embodiment, the weather forecast business may not alter the crop management history records.

As one example of the implementation of some embodiments with regard to a power supply business, the power supply business may be given limited access to crop co-manager 320 in association with an access level. In one embodiment, crop co-manager 320 is associated with a plurality of crop storage facilities. Crop storage facilities consume a large quantity of power. The crop storage facilities may include a power consumption node that monitors power consumption, power use timing, and power consumption requirements. Accordingly, this data may be included in the crop management history records that are associated with crop co-manager 320. A power supply company may access this data and coordinate power supply to coordinate with the demands of the crop storage facilities. In another embodiment, the power supply company may have power regulation access to the crop-co manager so the power supply company is able to program timing for power supply for the crop storage facilities. In this manner, the power supply company can monitor energy consumption, regulate energy consumption and time energy output to provide for energy conservation. In one embodiment, the power supply business does not have direct access to the policy data. In another embodiment, the power supply business may not alter the crop management history records.

The above examples are for exemplary purposes to highlight some of the benefits of an independent impartial crop co-manager that provides limited access in association with a plurality of crop storage facilities across a crop market. Market participant 326 may include any entity, business, market, or group that may require access to crop management history data associated with one or more crop storage facilities. Moreover, examples of access level and limited access are for exemplary purposes to highlight some access levels and security levels that may increase reliability, efficiency and reduce fraud in a crop market. Examples of policies are for exemplary purposes to highlight some types of policies that may be used to co-manage a crop storage facility. Policies may include any type of policy that may facilitate reliability in crop quality, increase storage efficiency, promote crop safeness, and/or reduce fraud in a crop market.

FIG. 4 represents one embodiment of a network that facilitates security for impartial co-management to aid crop marketing. System 400 represents a general modular overview network and security aspects of the present disclosure. Aspects of system 400 may be integrated as a combination of software and hardware elements. Software elements, hardware elements, storage facilities, managers and other system elements are depicted herein for explanatory purposes only and not for limiting the configuration to multiple elements or a single element performing several functions. Aspects of system 400 may reside on a single computing device or a plurality of computing devices and servers in communication with one another.

In FIG. 4, exemplary system 400 may include remote site 402 having one or more crop storage facilities 404. In one aspect, remote site 402 is interfaced with first co-manager site 406, second co-manager site 408, third co-manager site 410, and Nth co-manager site 412 via first network 414 and/or Nth network 416, respectively. Exemplary system 400 represents some aspects of crop co-manager redundancy that provides security and safety upon the incapacity of a crop co-manager. For example, in the situation where first crop co-manager 418 fails, crop co-managers associated with second co-manager site 408, third co-manager site 410 and/or Nth co-manager site 412 may provide services to remote site 402.

Second co-manager site 408 is one exemplary configuration associated with some aspects of the present disclosure. Second co-manager site 408 may include a plurality of redundant crop co-managers located at a single site. Third co-manager site 410 is another exemplary configuration associated with some aspects of the present disclosure. Third co-manager site 410 may be interfaced with an off-site security server 420 that includes a security manager 422. Nth co-manager site 412 is another exemplary configuration associated with some aspects of the present disclosure. Nth co-manager site 412 may include Nth crop co-manager 424 that includes security manager 426. The examples referenced herein in association with FIG. 4 are for exemplary purposes. System 400 may include any system configuration or scheme that provides redundancy, facilitates security, and/or facilitates aspects of impartial co-management to aid crop marketing.

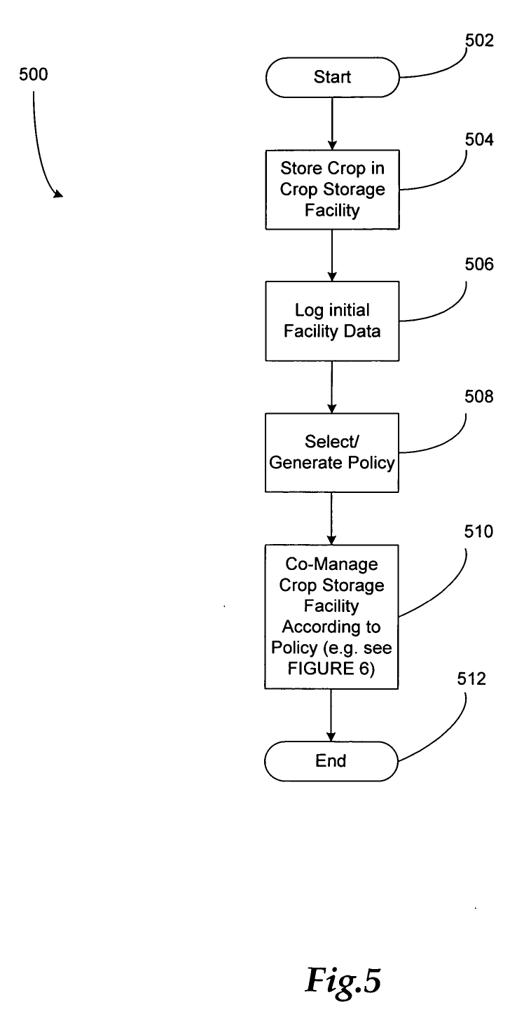

FIG. 5 represents a logical flow diagram of one aspect of the present disclosure. Process 500 includes aspects of co-managing a crop storage facility according to a policy. Process 500 starts at starting block 502 and flows to block 504 where a crop is stored in a crop storage facility. In one aspect, a crop is harvested from a field and stored in a crop silo, crop bin or any other type of storage that is capable of maintaining a crop, grain, seed and/or any other type of agricultural product. In another aspect, a crop storage facility includes a crop transportation vehicle. In such a situation, the holding area of the crop transportation vehicle is a crop storage facility.

Process 500 continues to block 506 where initial facility data is logged. Initial facility data may include any data that is associated with a crop objective, crop condition, crop ownership, crop destination, crop storage requirements, a desired crop grade, etc. In one embodiment, a crop owner, having an appropriate access level, logs the initial facility data into the crop co-manager. In another embodiment, the crop owner logs the initial facility data into a controller and the controller transmits the initial facility data to the crop-co manager. Logging initial facility data may further include a security access. The security access may include a biometric identification login, a web-based login, a secure web-based login, a virtual private network link, a client application based login, an encrypted login, a modem-based login, a dialup based login, an asymmetric public key cryptography, one time pad encryption and/or a security hash algorithm. The security access may be arranged to receive a request for access, determine an access level associated with the request, and reject requests from the determined access level is insufficient for the request.

Process 500 continues to block 508 where a policy is selected/generated. The policy may be selected/generated in light of the initial facility data. In aspects of the present disclosure, the policy includes a conditioning algorithm that is configured to drive nodes to achieve objectives associated with the initial facility data. Process 500 continues to block 510 where the crop storage facility is co-managed according to the policy. Process 500 ends at end block 516.

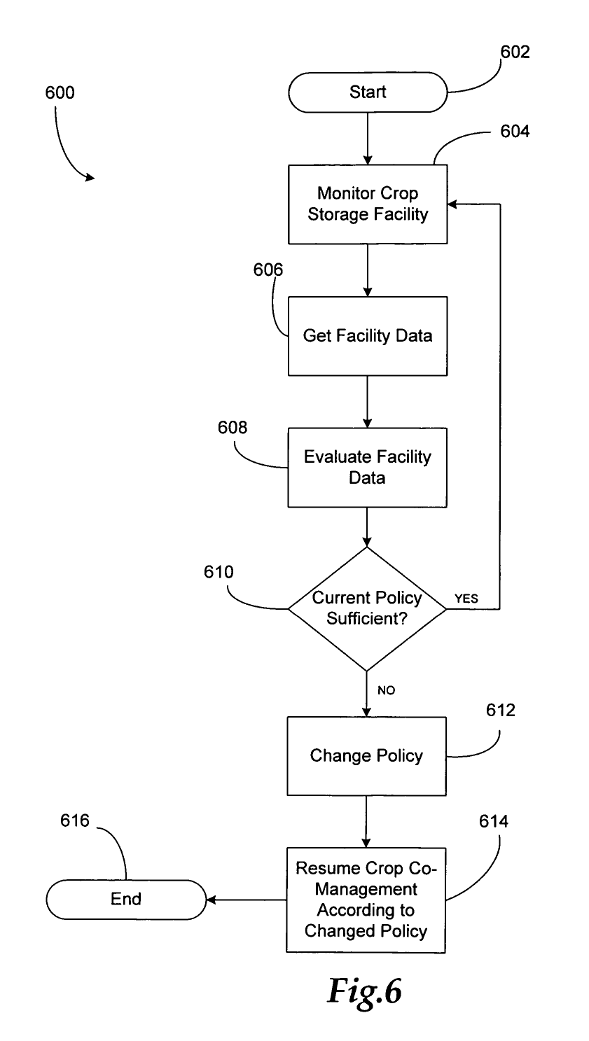

FIG. 6 represents a logical flow diagram of one aspect of the present disclosure. Process 600 includes aspects of co-managing a crop storage facility according to a policy. Process 600 begins at starting block 602 and continues to block 604 where a crop storage facility is monitored. In aspects of the present disclosure, monitoring the crop storage facility includes a master/slave relationship between a node and a controller. Monitoring the crop storage facility may also include a master/slave relationship with the crop co-manager and the controller. In one embodiment, the controller polls the status of the node. In another embodiment, the controller generates facility data that includes data associated with the operation of the nodes.

Process 600 continues to block 606 where facility data is obtained. In one aspect, the crop co-manager requests facility data from the controller. The controller transmits the facility data upon receiving the request. In another aspect, the crop co-manager receives a notification from the controller indicating that the controller has facility data. The crop co-manager requests facility data from the controller, and the controller transmits the facility data upon receiving the request. In another aspect, the crop co-manager polls the controller for data periodically for facility data. In yet another aspect, the controller sends data to the crop co-manager periodically.

Process 600 continues to block 608 where the facility data is evaluated. Evaluation of facility data may include evaluation of an instantaneous condition, average condition over a time period, rate of change of a condition, the mean of a condition over a time period, and the like. Evaluation may also include changes in initial facility data instituted by a crop owner.

Process 600 continues to decision block 610, where it is determined whether a current policy is sufficient. In one embodiment, the evaluated facility data may indicate that a current policy is sufficient to achieve a goal or objective with regard to the crop. In such a situation, process 600 loops back to block 604 where the crop storage facility is monitored. In another embodiment, the evaluated facility data may indicate that a current policy is insufficient to achieve a goal or objective with regard to the crop. In such a situation, process 600 continues to block 612 where the policy is changed. The policy may be changed by modifying the current policy, selecting a new policy, generating a new policy, and/or the like. Process 600 continues to block 614 where co-management of the crop storage facility is resumed. Process 600 ends at end block 616.

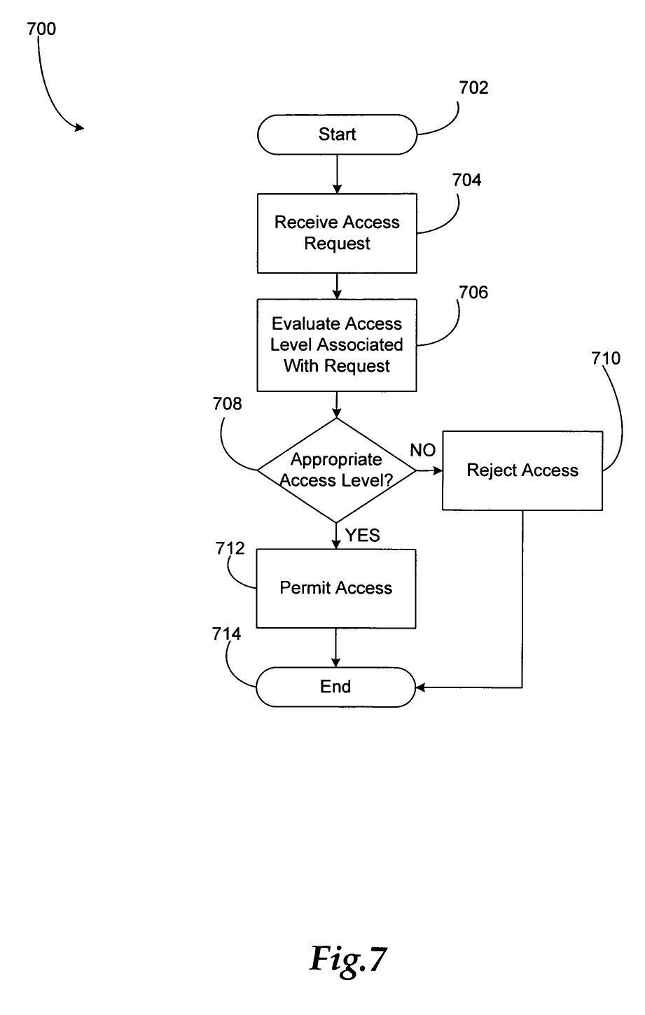

FIG. 7 represents a logical flow diagram of one aspect of the present disclosure. Process 700 includes aspects for limiting access to data and processes associated with the storage of a crop. Process 700 begins at start block 702 and continues to block 704 where a request for access is received. The request for access may include a biometric identification login, a web-based login, a secure web-based login, a virtual private network link, a client application based login, an encrypted login, a modem-based login, and/or a dialup based login. In another embodiment, controller security includes asymmetric public key cryptography, one time pad encryption and/or a security hash algorithm.

Process 700 continues to block 706 where the access level associated with the request is evaluated. Such evaluation may include verifying/authentication of identification, a pass-code, or the like. An access level may include a public access level where data is publicly accessible. An access level may also include a customer access level where data is accessible to a service subscriber. An access level may further include a restricted access for sensitive data. In one embodiment, restricted access is granted to market participants having a high level of accountability (e.g. government entity). Process 700 continues to decision block 708 where it is determined if the request includes the appropriate level of access. If the requested level of access is not appropriate, process 700 continues to block 710 where access is rejected. Process 700 then continues to end block 714. If the requested level of access is appropriate, process 700 continues to block 712 where access is permitted. Permitted access may allow a requesting entity to view a crop management history record, set up accounts or input data associated with a crop transaction. Process 700 then continues to end block 714.

As discussed herein, the present disclosure includes impartial co-management of a crop market. Such impartial co-management of a crop market promotes a uniform crop standard across a vast geographic area. Impartial co-management of a crop market also promotes reliability in crop data, increases efficiency of crop storage, reduces susceptibility to fraud or spoofing, and promotes the traceability of crops to an origin. Impartial co-management of a crop market further promotes limited access that provides various market entities with crop management data and allows data input to promote efficient and safe online crop market transactions.

Illustrative Operating Environment

Referring to FIG. 1, an exemplary system for implementing the disclosure includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include application 120, which includes aspects of impartial co-management to aid crop marketing. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included. All these devices are known in the art and need not be discussed at length here.

Computing device 100 also contains communication connection(s) 116 that allow the device to communicate with other computing devices 118, such as over a network or a wireless mesh network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

FIG. 2 illustrates a mobile computing device that may be used in one exemplary embodiment of the present disclosure. With reference to FIG. 2, one exemplary system for implementing the disclosure includes a mobile computing device, such as mobile computing device 200. The mobile computing device 200 has processor 260, memory 262, display 228, and keypad 232. Memory 262 generally includes both volatile memory (e.g., RAM) and non-volatile memory (e.g., ROM, Flash Memory, or the like). Mobile computing device 200 includes operating system 264, which is resident in memory 262 and executes on processor 260. Keypad 232 may be a push button numeric dialing pad (such as on a typical telephone), or a multi-key keyboard (such as a conventional keyboard). Display 228 may be a liquid crystal display, or any other type of display commonly used in mobile computing devices. Display 228 may be touch-sensitive, and would then also act as an input device.

One or more application programs 266 are loaded into memory 262 and run on operating system 264. Examples of application programs include phone dialer programs, e-mail programs, scheduling programs, PIM (personal information management) programs, word processing programs, spreadsheet programs, Internet browser programs, and so forth. Mobile computing device 200 also includes non-volatile storage 268 within memory 262. Non-volatile storage 268 may be used to store persistent information which should not be lost if mobile computing device 200 is powered down. Applications 266 may use and store information in storage 268, such as e-mail or other messages used by an e-mail application, contact information used by a PIM, appointment information used by a scheduling program, documents used by a word processing application, and the like. In one embodiment, applications 266 further include application 280, which includes aspects of impartial co-management to aid crop marketing.

Mobile computing device 200 has power supply 270, which may be implemented as one or more batteries. Power supply 270 might further include an external power source, such as an AC adapter or a powered docking cradle that supplements or recharges the batteries.

Mobile computing device 200 is shown with two types of external notification mechanisms: LED 240 and audio interface 274. These devices may be directly coupled to power supply 270 so that when activated, they remain on for a duration dictated by the notification mechanism even though processor 260 and other components might shut down to conserve battery power. LED 240 may be programmed to remain on indefinitely until the user takes action to indicate the powered-on status of the device. Audio interface 274 is used to provide audible signals to and receive audible signals from the user. For example, audio interface 274 may be coupled to a speaker for providing audible output and to a microphone for receiving audible input, such as to facilitate a telephone conversation.

Mobile computing device 200 also includes radio interface layer 272 that performs the function of transmitting and receiving communications, such as radio frequency communications. Radio interface layer 272 facilitates wireless connectivity between mobile computing device 200 and the outside world, via a communications carrier or service provider. Transmissions to and from radio interface layer 272 are conducted under control of operating system 264. In other words, communications received by radio interface layer 272 may be disseminated to application programs 266 via operating system 264, and vice versa.

The above specification, examples and data provide a complete description of the manufacture and use of the composition of the disclosure. Since many embodiments of the disclosure can be made without departing from the spirit and scope of the invention, the invention resides in the claims hereinafter appended.

What is claimed is:

1. A co-management system for impartial co-management to aid crop marketing, the co-management system comprising:
at least one crop storage site, wherein the at least one crop storage site comprises:
a crop storage facility;
a node associated with the crop storage facility; and
a controller associated with the crop storage facility for controlling crop storage, wherein the controller is configured according to a policy; and
a crop co-manager that is arranged in communication with the at least one of the crop storage facility, the facility sensor, and the controller, wherein the crop co-manager is configured to:
obtain facility data;
transmit the policy to the controller, wherein the policy is configured according to a crop storage objective; and
record crop management history data for limited access by a market participant.

2. The system of claim 1, wherein the facility data includes at least one of:
initial facility data, weather data, temperature data, relative humidity data, barometric pressure data, position data, time data, static pressure data, crop condition data, environmental condition data, crop weight data, crop heat data, crop moisture data, power consumption data, crop origin data, shipping data, ownership data, escrow data, radio frequency identification data, proactive commingling data, and trace data.

3. The system of claim 1, wherein the policy comprises: at least one crop-conditioning algorithm configured to drive a functionality associated with the controller.

4. The system of claim 1, wherein the crop management history data includes a history of at least one of: weather, temperature, relative humidity, barometric pressure, position, time, static pressure, crop condition, environmental condition, weight, heat, moisture, power consumption, origin, shipping, ownership, tracing, proactive commingling, radio frequency identification data, crop grade, and crop objectives.

5. The system of claim 1, wherein the market participant comprises at least one of: a crop owner, a crop storage facility manager, a financial business, an escrow business, an insurance business, a shipping business, a crop purchaser, a crop trade business, a crop exchange market, a tracking business, a weather forecast business, and a power supply business.

6. The system of claim 1, wherein the crop co-manager is configured to maintain a criteria associated with crop quality by:
evaluating the facility data;
selecting a new policy setting for the controller in response to the evaluated facility data; and
communicating the new policy setting to the controller.

7. The system of claim 1, further comprising: a security manager that is arranged in cooperation with the crop co-manager, wherein the security manager is configured to:
receive a request for access;
evaluate an access level associated with the request; and
reject requests when the evaluated access level is insufficient for the request.

8. The system of claim 1, wherein the crop co-manager comprises a security manager that is arranged in cooperation with the crop market co-manager, wherein the security manager is configured to:
receive a request for access;
evaluate an access level associated with the request; and
reject requests when the evaluated access level is insufficient for the request.

9. The system of claim 1, wherein the crop co-manager is further configured to receive requests from the market participant via a communication interface, wherein the communication interface comprises at least one of: a serial communication interface, a parallel communication interface, an Ethernet interface, a twisted pair cabling interface, a wireless interface, a fiber optics interface, a power line carrier interface, a satellite interface, a dial-up interface, a web based login, a secure web based login, a virtual private network link, a hard-wired connection, a client application based login, a biometric identification login, an encrypted login, a modem based login, a dialup based login, asymmetric public key cryptography, one time pad encryption, and a security hash algorithm.

10. A computer-implemented method for impartial co-management to aid crop marketing, the method comprising:
obtaining facility data associated with the management of at least one crop storage facility;
selecting a policy associated with the facility data, wherein the policy is configured to manage the at least one crop storage facility to achieve an objective; and
generating a crop management history record, wherein the crop management history record is configured for accessibility to a market participant having an appropriate access level.

11. The computer-implemented method of claim 10, wherein the access level comprises at least one of: public access, customer access, and restricted access.

12. The computer-implemented method of claim 10, wherein the facility data includes at least one of: initial facility data, weather data, temperature data, relative humidity data, barometric pressure data, position data, time data, static pressure data, crop condition data, environmental condition data, crop weight data, crop heat data, crop moisture data, power consumption data, crop origin data, shipping data, ownership data, escrow data, radio frequency identification data, proactive commingling data, and trace data.

13. The computer-implemented method of claim 10, wherein the policy comprises at least one crop-conditioning algorithm configured to drive a functionality associated with the controller.

14. The computer-implemented method of claim 10, wherein the crop management history record comprises a history of at least one of: weather, temperature, relative humidity, barometric pressure, position, time, static pressure, crop condition, environmental condition, weight, heat, moisture, power consumption, origin, shipping, ownership, tracing, proactive commingling, escrow data, radio frequency identification data, crop grade, and crop objectives.

15. The computer-implemented method of claim 10, wherein the market participant comprises at least one of: a crop owner, a crop storage facility manager, a financial business, an escrow business, an insurance business, a shipping business, a crop purchaser, a crop trade business, a crop exchange market, a tracking business, a weather forecast business, and a power supply business.

16. The computer-implemented method of claim 10, further comprising:
receiving a request for access to the crop management history record;
evaluating an access level associated with the request;
rejecting requests when the evaluated access level is insufficient for the request; and
accepting requests when the evaluated access level is sufficient for the request, wherein access is permitted for at least one of: viewing the crop management history record, and inputting crop transaction data.

17. The computer-implemented method of claim 10, further comprising interfacing the crop management history record with the market participant, wherein the communication interface comprises at least one of: a serial communication interface, a parallel communication interface, an Ethernet interface, a twisted pair cabling interface, a wireless interface, a fiber optics interface, a power line carrier interface, a satellite interface, a dial-up interface, a biometric identification login, a web based login, a secure web based login, a virtual private network link, a hard-wired connection, a client application based login, an encrypted login, a modem based login, a dialup based login, asymmetric public key cryptography, one time pad encryption, and a security hash algorithm.

18. A system for impartial co-management to aid crop marketing, the system comprising:
a crop storage means, wherein the crop storage means is arranged to maintain a crop therein;
a node means, wherein the node means is associated with the crop storage means and configured for at least one of: sensing conditions associated with the crop storage means and rectifying conditions associated with the crop storage means;
a controller means, wherein the controller means is associated with the crop storage means and configured to communicate with the node means according to a policy; and
a crop co-management means, wherein the crop co-management means is configured to: obtain facility data, evaluate a policy according to the facility data, transmit the policy to the controller, and generate a crop management history record.

19. The system of claim 18, further comprising a security manager means, wherein the security manager means is configured to receive a request for access, evaluate an access level associated with the request, and reject requests when the evaluated access level is insufficient for the request.

20. The system of claim 18, further comprising a controller security means, wherein the controller security means is configured to receive a request for access, evaluate an access level associated with the request, and reject requests when the evaluated access level is insufficient for the request.

21. The system of claim 19, wherein the security manager means is arranged in at least one of: in communication with the crop co-manager means, and as a portion of the crop co-manager means.

22. The system of claim 20, wherein the controller security means is arranged in at least one of: in communication with the controller means, and as a portion of the controller means.
